(19) United States
(12) Patent Application Publication
(10) Pub. No.: US 2016/0030871 A1
(43) Pub. Date: Feb. 4, 2016

(54) FILTER WITH MAGNETIC SEAL

(71) Applicant: Camfil USA, Inc., Riverdale, NJ (US)

(72) Inventor: Michael T. KRAUSE, Plainfield, NJ (US)

(21) Appl. No.: 14/451,392

(22) Filed: Aug. 4, 2014

(51) Int. Cl. B01D 46/00; B01D 46/30; B01D 53/04

(52) U.S. Cl. CPC B01D 46/0005; B01D 53/0407; B01D 46/30

(57) ABSTRACT

An air filtration system that comprises a filter assembly having a magnetic seal mounted in a holding frame. The magnetic seal is disposed between the filter assembly and the holding frame to prevent air from bypassing a filter media of the filter assembly. The magnetic seal is disposed between an outer shoulder of a filter frame of the filter assembly and an inner shoulder of the holding frame.

### BACKGROUND

1. Field of the Disclosure

Embodiments of this disclosure generally relate to a magnetic filter seal.

2. Description of the Related Art

An air filtration system enhances air quality by removing impurities, such as odors, volatile organic compounds, dust, pollen, mold, and bacteria, from the air. The air filtration system has a holding frame for mounting a filter assembly. The filter assembly has a filter frame for supporting one or more filter elements comprised of a media configured to remove air impurities. The filter element may be configured as a gas phase and/or particulate filter element, for example using activated carbon filter media and/or wet laid or spun-bonded media and the like. As air flows into the filter assembly and through the filter elements, the air impurities are captured by the filter media.

When the filter assembly is mounted to the holding frame, however, a small, non-sealed gap is formed between the exterior of the filter assembly and the interior of the holding frame. Air that flows through the gap bypasses the filter assembly and is not filtered. Thus, the efficiency of the air filtration system is compromised.

Therefore, there is a need for apparatus and methods for preventing air flow from bypassing a filter assembly of air filtration systems.

### SUMMARY

An filter assembly comprising a filter frame having an open front end and an open rear end, wherein the open rear end has an outer shoulder; a filter media coupled to the filter frame; and a magnetic seal coupled to the outer shoulder of the filter frame, wherein the magnetic seal is disposed about the entire circumference of the open rear end of the filter frame.

An air filtration system comprising a filter assembly having a filter frame and a filter media, the filter frame having an outer shoulder; a holding frame having an inner shoulder, wherein the filter frame is mounted in the holding frame such that the outer shoulder of the filter frame engages the inner shoulder of the holding frame; and a magnetic seal disposed between the outer shoulder of the filter frame and the inner shoulder of the holding frame.

### BRIEF DESCRIPTION OF THE DRAWINGS

So that the manner in which the above recited features can be understood in detail, a more particular description of the embodiments briefly summarized above may be had by reference to the embodiments below, some of which are illustrated in the appended drawings. It is to be noted, however, that the appended drawings illustrate only typical embodiments and are therefore not to be considered limiting of its scope, for the embodiments may admit to other equally effective embodiments.

FIG. 1 illustrates a front perspective view of an air filtration system, according to one embodiment disclosed herein.

FIG. 2 illustrates an exploded perspective view of a filter assembly having a magnetic seal, and a holding frame, according to one embodiment disclosed herein.

FIG. 3A illustrates a horizontal sectional view of the filter assembly having the magnetic seal, and the holding frame, according to one embodiment disclosed herein.

FIG. 3B illustrates an enlarged view of a horizontal section portion of the filter assembly having the magnetic seal, and the holding frame, according to one embodiment disclosed herein.

FIG. 4A illustrates a vertical sectional view of the filter assembly having the magnetic seal, and the holding frame, according to one embodiment disclosed herein.

FIG. 4B illustrates an enlarged view of a vertical section portion of the filter assembly having the magnetic seal, and the holding frame, according to one embodiment disclosed herein.

FIG. 5A and FIG. 5B illustrate alternative embodiments of the filter assembly.

FIG. 6A and FIG. 6B illustrate alternative embodiments of the magnetic seal.

### DETAILED DESCRIPTION

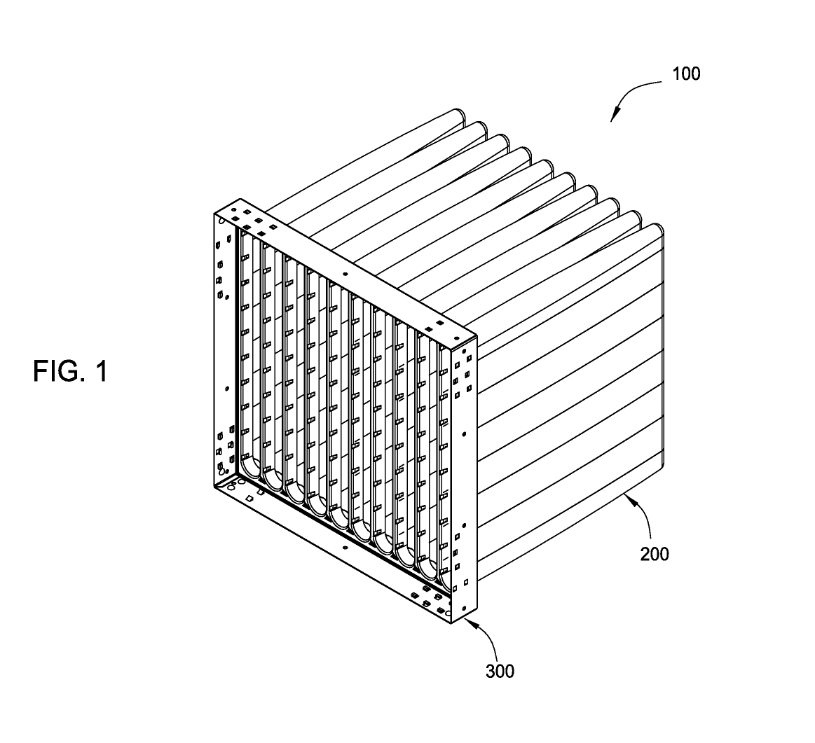

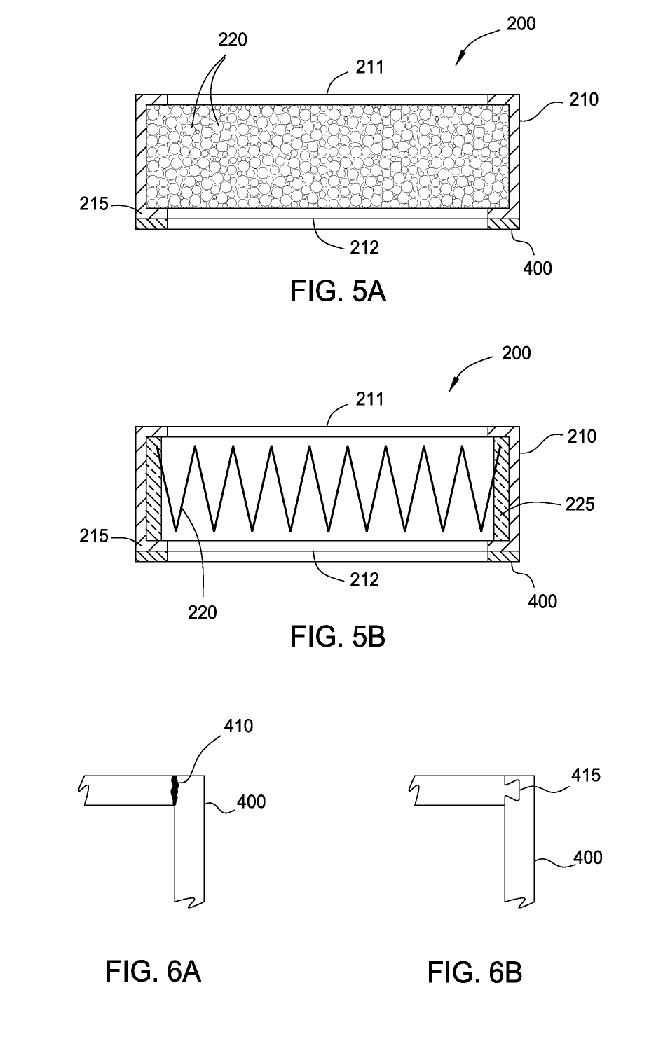

FIG. 1 illustrates a front perspective view of an air filtration system 100, according to one embodiment disclosed herein. The system 100 includes a filter assembly 200 and a holding frame 300. The filter assembly 200 is mounted in the holding frame 300. Although the filter assembly 200 is illustrated as a bag filter assembly, the embodiments of this disclosure can be used with any type of filter assembly that is mountable to a holding frame. Examples of other types of filter assemblies are discussed further below with reference to FIG. 5A and FIG. 5B.

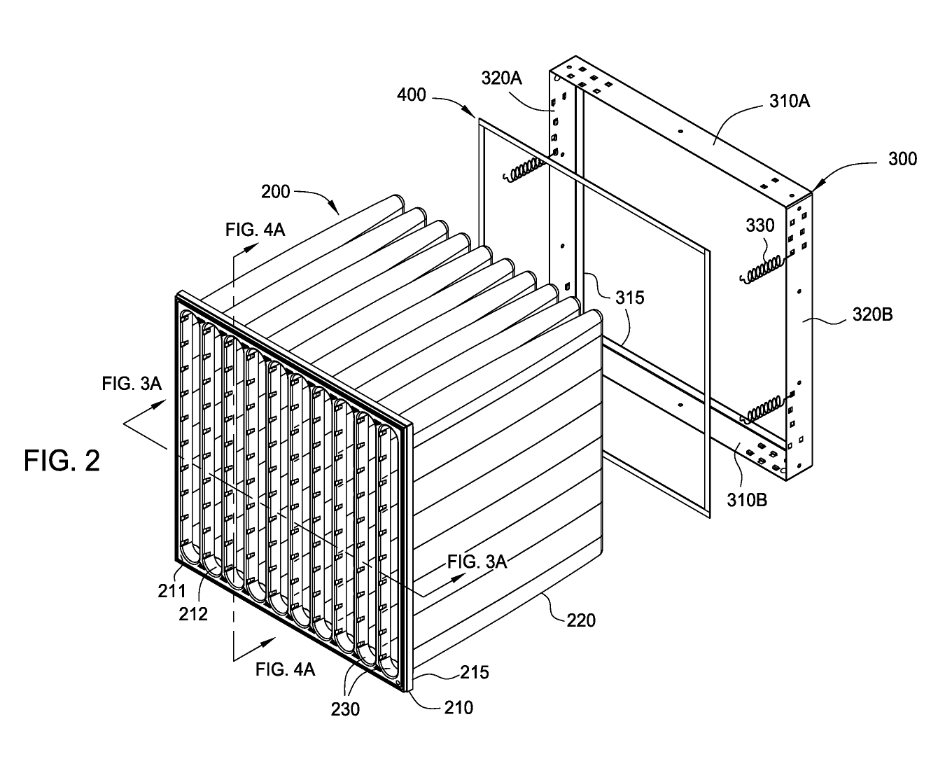

FIG. 2 illustrates an exploded perspective view of the filter assembly 200 having a magnetic seal 400 which holds the filter assembly 200 to the holding frame 300. The filter assembly 200 in addition to the magnetic seal 400 includes a filter frame 210 and filter media 220. The magnetic seal 400 is described herein as being a part of the filter assembly 200, but alternatively the magnetic seal 400 may be a separate assembly and/or may be part of the holding frame 300.

In the embodiment depicted in FIG. 2, the filter media 200 is shown in the form of a plurality of individual filter bags with the open ends of the individual filter bags coupled to the filter frame 210. The filter frame 210 may have a quadrilateral shape. The filter frame 210 includes an open front end 211 having a plurality of openings 230, and an open rear end 212 having an outer shoulder 215 that engages an inner shoulder 315 of the holding frame 300 when the bag filter assembly 200 is mounted within the holding frame 300. The outer shoulder 215 may be substantially perpendicular to the centerline of the filter frame 210. The filter frame 210 may be formed from materials, such as iron, steel, aluminum, nickel, cobalt, plastic, fiberglass reinforced plastic, cardboard, wood, and/or any other material sufficient to structurally support the filter media 220.

The magnetic seal 400 is disposed between the outer shoulder 215 of the filter frame 210 and the inner shoulder 315 of the holding frame 300. In one embodiment, the magnetic seal 400 is adhered to the outer shoulder 215 of the filter frame 210, for example using a pressure sensitive adhesive. The magnetic seal 400 forms a seal by the magnetic attachment and attraction to the materials forming the outer and inner shoulders 215, 315 to prevent air from flowing through the space between the outer shoulder 215 and the inner shoulder 315, thereby bypassing the filter media 220 when the filter assembly 200 is mounted in the holding frame 300. The seal formed by the magnetic seal 400 is disposed about the entire circumference of the open rear end of the filter frame 210 and thus the space between the outer and inner shoulders 215, 315 when the filter assembly 200 is mounted to the holding frame 300.

The magnetic seal 400 has a substantially square or rectangular shape but may include any other shape corresponding to the outer shoulder 215 of the filter frame 210 and/or the inner shoulder 315 of the holding frame 300. The magnetic seal 400 can be formed from a single piece of magnetic material, or from a plurality of strips of magnetic material, the ends of which are coupled together by an adhesive 410 as illustrated in FIG. 6A and/or by corresponding dovetail grooves 415 as illustrated in FIG. 6B according to alternative examples. The magnetic seal 400 can be formed in a Halbach array and/or as a flexible magnet, such as a high coercivity ferromagnetic compound disposed in a polymer binder. In one example, the magnetic seal 400 comprises a foamed polymer to make the magnet seal 400 more compliant. The magnetic seal 400 is formed from a magnetic material that attaches and attracts to metallic materials, such as iron, steel, nickel, cobalt, etc. At least the inner shoulder 315 of the holding frame 300 is formed from a material that has a magnetic attraction to the magnetic seal 400.

The filter frame 210 further includes one or more openings 230 through which air can flow and be directed through the filter media 220. Air impurities are captured by the filter media 220 to clean the air flowing through the filter assembly 200. The filter media 220 may be configured as a gas phase and/or particulate filter element, for example using activated carbon filter media and/or wet laid or spun-bonded media and the like. The filter media 220 may be formed out of glass, polymer fibers, and/or any other suitable type of filtering media. The filter assembly 200 may include a width within a range of about 280 mm to about 600 mm, a height within a range of about 280 mm to about 900 mm, and a depth of about 280 mm to about 900 mm.

The holding frame 300 has four sides including an upper panel 310A, a lower panel 310B, a right side panel 320A, and a left side panel 320B. The panels 310A, 310B, 320A, 320B are coupled together, such as by welded, riveted, and/or threaded connections, to form a substantially square or rectangular shaped tubular structure (e.g. a quadrilateral tube) with a front (first) open end, a back (second) open end, and an open interior disposed between the front and back open ends into which the bag filter assembly 200 can be inserted. The panels 310A, 310B, 320A, 320B may alternatively be an integral single piece member. The holding frame 300 may have a width selected to accommodate the filter assembly 200.

The panels 310A, 310B, 320A, 320B may be formed from metallic materials, such as iron, steel, nickel, cobalt, and/or any other material sufficient to structurally support the filter assembly 200. The rear sides of the panels 310A, 310B, 320A, 320B form the inner shoulder 315, which supports and prevents the filter assembly 200 from being inserted entirely through the holding frame 300. The holding frame 300 may optionally include one or more attachment members 330, such as spring clips, that are configured to securely attach the filter assembly 200 to the holding frame 300. If the magnetic seal 400 provides a sufficient force to secure the filter assembly 200 to the holding frame 300, the attachment members 330 may be omitted.

Since the magnetic seal 400 is coupled to the outer surface of the outer shoulder 215 of the filter frame 210, to assemble the air filtration system 100, the filter assembly 200 simply is inserted into the front end of the holding frame 300. The outer shoulder 215 of the filter frame 210 engages the inner shoulder 315 of the holding frame 300 with the magnetic seal 400 disposed therebetween to prevent air from flowing between the outer shoulder 215 of the filter frame 210 and the inner shoulder 315 of the holding frame 300. The inner shoulder 315 also prevents the filter assembly 200 from being inserted entirely through the holding frame 300.

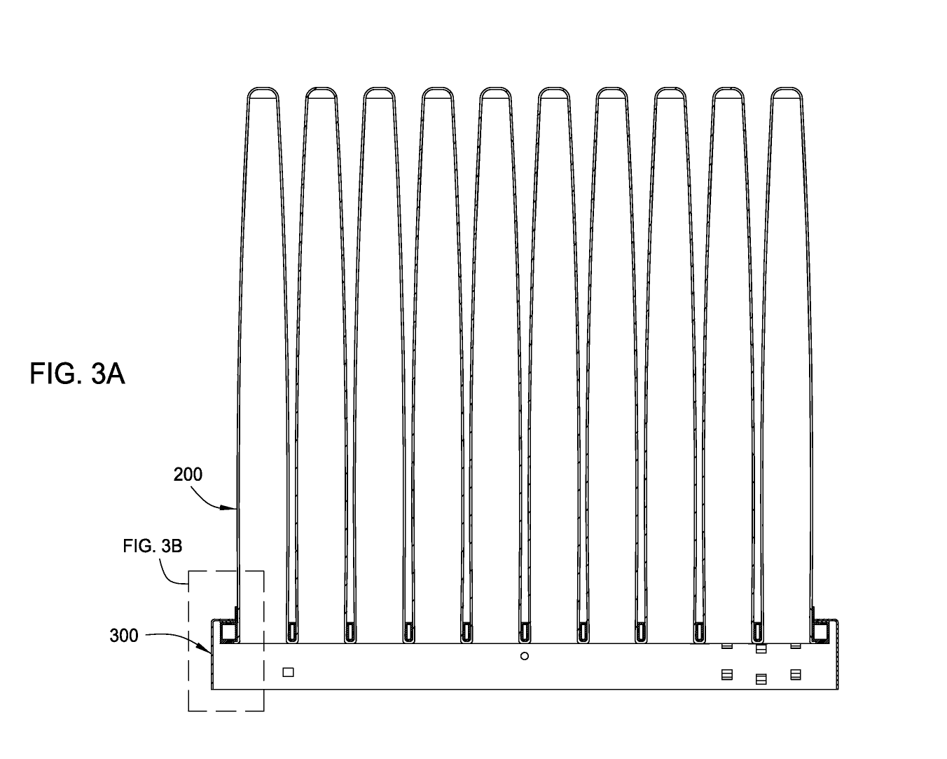

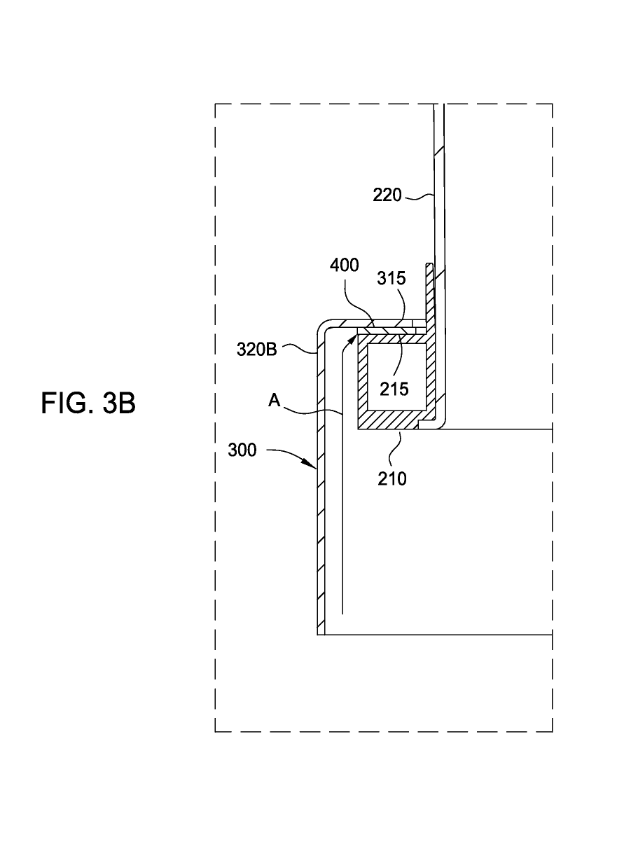

FIG. 3A illustrates a horizontal sectional view of the filter assembly 200 having the magnetic seal 400, and the holding frame 300. FIG. 3B illustrates an enlarged view of a horizontal section portion of the filter assembly 200 having the magnetic seal 400, and the holding frame 300. The outer perimeter of the filter frame 210 is less than the interior perimeter of the holding frame 300 such that the panels 310A, 310B, 320A, 320B surround the filter frame 210. The outer shoulder 215 of the filter frame 210 engages the inner shoulder 315 of the holding frame 300 with the magnetic seal 400 disposed therebetween. The magnetic seal 400 prevents air flow, illustrated by reference arrow “A”, from bypassing the filter media 220 through the space between the filter frame 210 and the right and left side panels 320A, 320B of the holding frame 300.

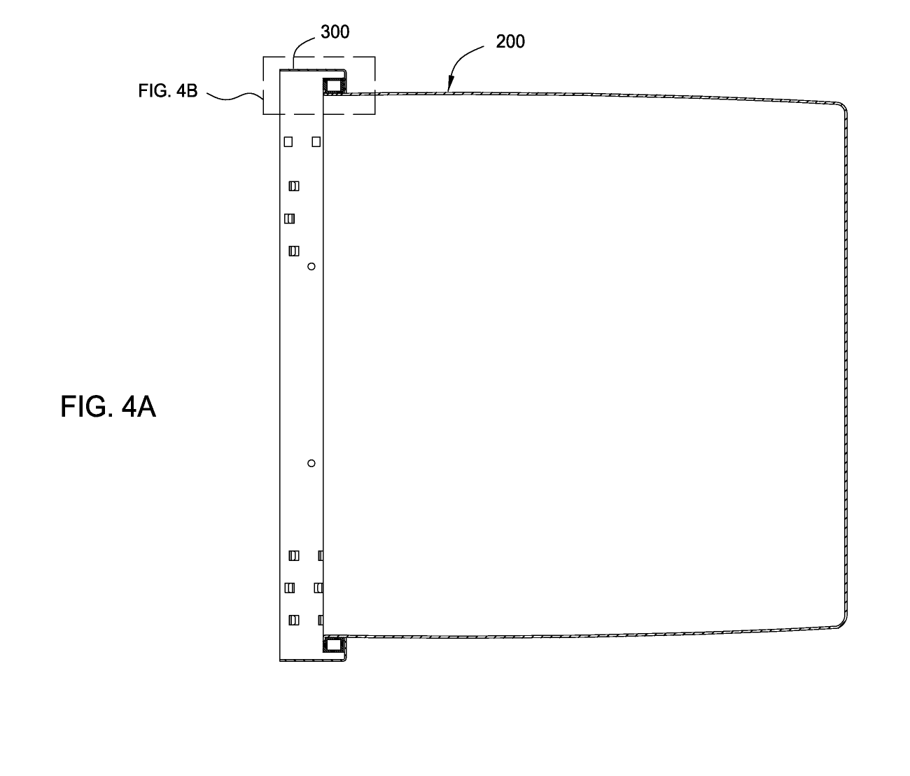

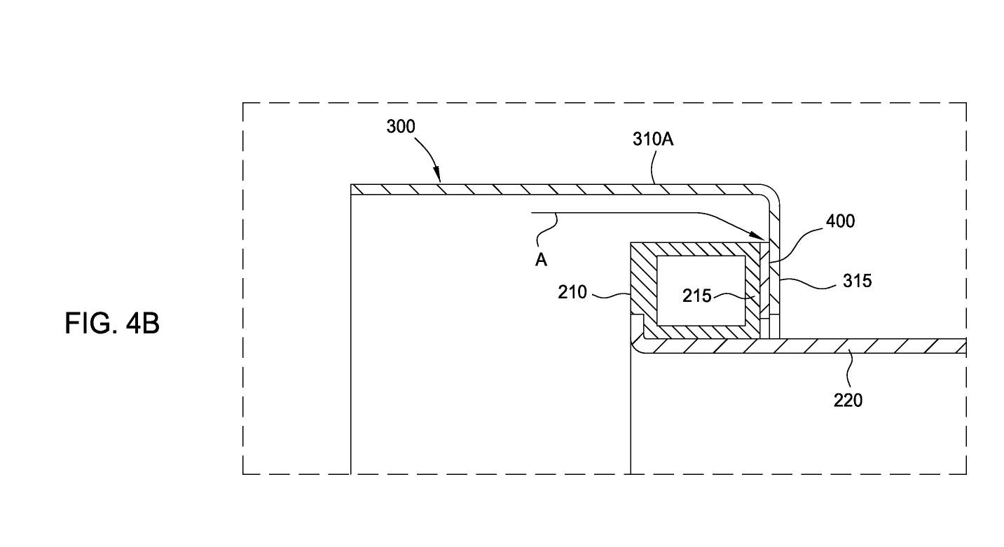

FIG. 4A illustrates a vertical sectional view of the filter assembly 200 having the magnetic seal 400, and the holding frame 300. FIG. 4B illustrates an enlarged view of a vertical section portion of the filter assembly 200 having the magnetic seal 400, and the holding frame 300. The outer perimeter of the filter frame 210 is less than the interior perimeter of the holding frame 300 such that the panels 310A, 310B, 320A, 320B surround the filter frame 210. The outer shoulder 215 of the filter frame 210 engages the inner shoulder 315 of the holding frame 300 with the magnetic seal 400 disposed therebetween. The magnetic seal 400 prevents air flow, illustrated by reference arrow “A”, from bypassing the filter media 220 through the space between the filter frame 210 and the upper and lower panels 310A, 310B of the holding frame 300.

FIG. 5A illustrates a sectional view of an alternative embodiment of the filter assembly 200 having the magnetic seal 400. The magnetic seal 400 is coupled to the outer shoulder 215 and disposed about the entire circumference of the open rear end 212 of the filter frame 210. The filter frame 210 is a rectangular or v-bank shaped structure having an open interior that is filled with the filter media 220, which may include activated carbon according to one example. When the filter assembly 200 illustrated in FIG. 5A is mounted in the holding frame 300, the magnetic seal 400 prevents air from bypassing the filter media 220 through the space between the filter frame 210 and the holding frame 300.

FIG. 5B illustrates a sectional view of an alternative embodiment of the filter assembly 200 having the magnetic seal 400. The magnetic seal 400 is coupled to the outer shoulder 215 and disposed about the entire circumference of the open rear end 212 of the filter frame 210. The filter frame 210 is a rectangular or v-bank shaped structure having an open interior that is filled with pleated filter media 220. A potting compound 225, such as urethane, and/or hot melt adhesives may also be disposed within the filter frame 210 to prevent air from leaking between the filter frame 210 and the filter media 220. When the filter assembly 200 illustrated in FIG. 5B is mounted in the holding frame 300, the magnetic seal 400 prevents air from bypassing the filter media 220 through the space between the filter frame 210 and the holding frame 300.

In one embodiment, the holding frame 300 may be permanently installed in a larger surrounding structure, such as an air duct of a building ventilation system. The magnetic seal 400 can be used with the filter assembly 200 on existing holding frames 300 to improve the efficiency of air filtration systems by preventing unfiltered air from bypassing the filter media 220 of the filter assembly 200. Although illustrated herein as a bag filter assembly 200, the magnetic seal 400 can be used with any type of filter assembly having a filter frame that is mountable to the holding frame 300.

While the foregoing is directed to certain embodiments, other and further embodiments may be devised without departing from the basic scope thereof, and the scope thereof is determined by the claims that follow.

What is claimed is:

1. An air filter assembly, comprising:
a filter frame having an open front end and an open rear end, wherein the open rear end has an outer shoulder;
a filter media supported by the filter frame; and
a magnetic seal coupled to the outer shoulder of the filter frame, wherein the magnetic seal is disposed about the entire circumference of the open rear end of the filter frame.

2. The assembly of claim 1, wherein the magnetic seal is adhered to the outer shoulder by an adhesive.

3. The assembly of claim 1, wherein the filter frame has a quadrilateral shape with an open interior formed between the open front end and the open rear end, wherein the filter media is disposed in the open interior.

4. The assembly of claim 1, wherein the filter media includes a plurality of filter bags coupled to the filter frame.

5. The assembly of claim 1, wherein the filter media includes activated carbon filtration media or particulate filtration media.

6. The assembly of claim 1, wherein the magnetic seal comprises a foamed polymer.

7. The assembly of claim 1, wherein the magnetic seal is formed from a single piece of magnetic material.

8. The assembly of claim 1, wherein the magnetic seal is formed from a plurality of magnetic strips.

9. The assembly of claim 1, wherein the magnetic seal is formed from a plurality of magnetic strips of material coupled together by corresponding dovetail grooves.

10. An air filtration system, comprising:
a filter assembly having a filter frame and a filter media, the filter frame having an outer shoulder;
a holding frame having an inner shoulder, wherein the filter frame is mounted in the holding frame such that the outer shoulder of the filter frame engages the inner shoulder of the holding frame; and
a magnetic seal disposed between the outer shoulder of the filter frame and the inner shoulder of the holding frame.

11. The system of claim 10, wherein the filter media comprises a plurality of bag filters each having an open end coupled to the filter frame.

12. The system of claim 10, wherein the filter frame, the holding frame, and the magnetic seal each have a substantially square or rectangular shape.

13. The system of claim 10, wherein at least the outer shoulder of the filter frame and the inner shoulder of the holding frame are formed from a metallic material.

14. The system of claim 10, wherein the magnetic seal is formed from a plurality of strips of magnetic material.

15. The system of claim 10, wherein the filter media includes activated carbon filtration media or particulate filtration media.

16. The system of claim 10, wherein the magnetic seal comprises a foamed polymer.

17. The system of claim 10, wherein the magnetic seal is adhered to the outer shoulder by an adhesive.

18. The system of claim 10, wherein the magnetic seal is formed from a plurality of magnetic strips of material coupled together by corresponding dovetail grooves.

19. The system of claim 10, wherein the magnetic seal provides an air seal between the filter assembly and the holding frame.
